(19) United States
(12) Patent Application Publication
(10) Pub. No.: US 2025/0169469 A1
(43) Pub. Date: May 29, 2025

(54) DETERMINING THE LOCATION OF AN ANIMAL

(71) Applicant: ALLFLEX AUSTRALIA PTY LTD, Queensland (AU)

(72) Inventors: Benjamin Thomas John WILKINSON, Queensland (AU); Brian Antony CLAYTON, Queensland (AU)

(73) Assignee: ALLFLEX AUSTRALIA PTY LTD, Queensland (AU)

(21) Appl. No.: 19/040,427

(22) Filed: Jan. 29, 2025

Related U.S. Application Data
(63) Continuation of application No. 17/429,559, filed on Aug. 9, 2021, now Pat. No. 12,239,098.

(51) Int. Cl. A01K 11/00; G01S 5/02; G01S 11/06; G06K 7/10

(52) U.S. Cl. CPC A01K 11/006; G01S 5/0289; G01S 5/0295; G01S 11/06; G06K 7/10366; G01S 2205/01

(57) ABSTRACT

Approaches for determining a location of an animal based on RSSI. An embodiment includes a method, comprising: receiving a first reading of an electronic animal identification tag attached to an animal from a first electronic tag reader; calculating a received signal strength indicator (RSSI) for the first reading; and determining a location of the animal based on the RSSI. Another embodiment includes a method, comprising: receiving a first reading of a first electronic animal identification tag attached to a first animal; calculating a received signal strength indicator (RSSI) for the first reading; receiving a second reading of a second 10 electronic animal identification tag attached to a second animal; calculating an RSSI for the second reading; and determining the location of the first animal based on the RSSI of the first reading and the RSSI of the second reading.

### CROSS-REFERENCE TO RELATED APPLICATIONS

This application is a continuation of U.S. patent application Ser. No. 17/429,559, filed Aug. 9, 2021, which is a national stage entry under 35 U.S.C § 371 of PCT/AU2019/050093, filed Feb. 8, 2019, the entire contents of which are incorporated by reference herein.

### FIELD

This relates to determining the location of an animal.

### BACKGROUND

Electronic animal identification tags can be used to identify animals. A tag is securely attached to an animal, often to the animal's ear. By reading the tag, the animal can be uniquely identified.

### SUMMARY

In a first example embodiment, there is provided a method, comprising: receiving a first reading of an electronic animal identification tag attached to an animal from a first electronic tag reader; calculating a received signal strength indicator (RSSI) for the first reading; and determining a location of the animal based on the RSSI.

In a second example embodiment, there is provided a method, comprising: receiving a first reading of a first electronic animal identification tag attached to a first animal; calculating a received signal strength indicator (RSSI) for the first reading; receiving a second reading of a second electronic animal identification tag attached to a second animal; calculating a received signal strength indicator for the second reading; and determining the location of the first animal based on the RSSI of the first reading and the RSSI of the second reading.

### BRIEF DESCRIPTION OF THE DRAWINGS

The invention is described by way of example with reference to the drawings, which show some embodiments of the invention. However, these are provided for illustration only. The invention is not limited to the particular details of the drawings and the corresponding description.

FIG. 1 shows an example method for determining the location of an animal according to a first embodiment.

FIG. 2 shows an animal tag reading system which can use the method of FIG. 1.

FIG. 3 shows an example method for determining the location of an animal according to a second embodiment.

FIG. 4 shows an animal tag reading system which can use the method of FIG. 3.

### DETAILED DESCRIPTION

In some embodiments, there is provided a method for determining the location of an animal, and consequently, the location of an animal to which the tag is attached. A first read of an electronic tag attached to the animal is received by a first tag reader. An RSSI for the first read is calculated.

A location of the electronic tag is then determined based on the RSSI. In other embodiments, there is provided a method for identifying an electronic animal identification tag is at a given location. A reader receives a first read of a first tag attached to a first animal and a second read of a second tag attached to a second animal. Based on the RSSI of each of the reads, the location of the first animal can be derived (at least relative to the second animal).

Using the RSSI allows a tag to be associated with a location. In different cases, this may enable a location of a particular animal to be identified, or an animal at a particular location to be identified.

For example, some stockyards have multiple races at an entrance or exit, and each race has a reader to read the tags of the animals passing through. Different animals proceed down the various races in parallel. This improves throughput, compared to having a single entrance or exit. However, because the races are close together, there is a risk of cross-read: that is, a reader may read a tag of an animal in a neighboring race. This can make it difficult to determine which race an animal passed through. However, the RSSI of a read of an electronic animal identification tag tends to decrease over distance, so an RSSI of a reading from a reader close to the tag tends to be higher than a reading from a reader further from the tag. When an animal passes through a race, the tag of that animal should be closer to that race's reader than to any other race's reader. Thus the RSSI can be used to determine the location of the tag, and consequently the location of the animal to which the tag is attached.

### Determining the Location of an Animal: First Embodiment

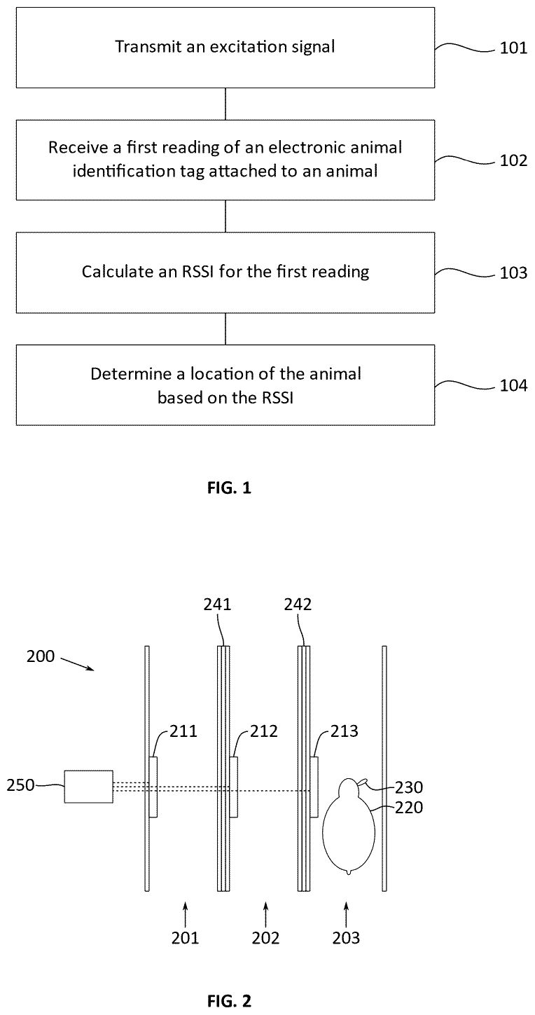

FIG. 1 shows an example method for determining the location of an animal. This method is performed using a system comprising at least one electronic tag reader.

At step 101, an electronic tag reader transmits an excitation signal. The purpose of the excitation signal is to energize an electronic animal identification tag attached to an animal. The excitation signal may be generated periodically, such as every 100 ms, and may last for a predetermined portion of the period, such as 40% of the period.

At step 102, an electronic tag reader (which may be the same electronic tag reader that performed step 101) receives a first reading of an electronic animal identification tag. This reading comprises an identifier, such as a 96-bit electronic product code. The purpose of the identifier is to uniquely identify the animal to which it is attached. For example, if multiple electronic animal identification tags are attached to the same animal, each tag may have the same identifier.

At step 103, a received signal strength indicator (RSSI) is calculated for the reading. This may be performed by the electronic tag reader which performed step 102, or by a separate controller. The RSSI reflects the strength of the signal received from the tag. A greater signal strength leads to a higher RSSI. The RSSI may be computed as a function of the power level (such as in milliwatts or decibels with reference to one milliwatt) of the signal. The RSSI tends to vary by distance.

Thus, all things being equal, a tag that is closer to the reader will tend to have a higher RSSI than a tag further from the reader.

In some cases, the RSSI is a relative figure, such as a signal strength relative to the average signal strength received by the reader (potentially over recent period). In such a case, a positive RSSI may mean that the signal strength of a received reading is greater than average.

At step 104, a location of the animal is determined based on the RSSI. This may be performed by a controller.

A location may be a relatively coarse area, such as a pen within a stockyard or a race in a multiple-race tag reader system. In some cases, these are associated with one of more readers. For example, each pen or race may have a corresponding reader.

When one or more readings of a tag from a single reader are available, the RSSI of the one or more readings may determine whether that tag is in a location corresponding to that reader. In some cases, if the RSSI of at least one reading is above a threshold value, then the tag is determined to be in that location. This threshold value may be determined based on a desired threshold distance. Since a greater RSSI tends to mean that the tag is close to the reader, a higher threshold tends to provide a positive determination only if the tag is in a closer proximity to the reader.

In other cases, the RSSI may be used to approximate a distance from the reader. RSSI tends to correlate with the distance of the tag from the reader. By using this correlation, an approximate distance from the reader can be calculated. For example, this may use a model trained on sample RSSI values and corresponding distances.

In this way, the usage of RSSI may result in a more accurate determination of the location of an electronic animal identification tag, and consequently of the location of an animal.

When one or more readings are available from each of multiple readers, and each reader is associated with a different location, the RSSI may be used to determine which of the locations the tag is in. In some cases, the location is determined on the basis of the reading with the highest RSSI only.

However, in some cases, accuracy may be improved by determining the location based on multiple readings. Thus, each of the readings may be considered together to determine the location.

For example, if readings are received from multiple readers in a sequence, the RSSI may form a curve having its maximum corresponding to a reader in the centre of the sequence of readers. In this case, the location of the tag may be the location of the centre reader.

In some cases, the determination of location occurs in real time. This may be useful when certain parts of a reader system are automatically controlled on the basis of the reading. In some arrangements, an animal may enter a race which a closed egress gate. When the animal's tag has been read, the corresponding gate is opened to allow the animal to exit the race. Such a system requires that the location of the electronic tag be determined in real time (that is, with a lag of less than a few seconds) in order for the system to operate efficiently.

In some cases, this occurs substantially after the reading was received. Each reading may be stored. These may be stored locally, on a memory of the reader. Additionally or alternatively, the readings may be sent to a remote device, such as to a controller. The remote device may receive readings from multiple readers, and can determine a location based on the multiple readings.

For example, after all animals have passed through a reader system with multiple races, the readings may be analysed to determine the paths of the animals through the system, and in particular, which race an animal passed through.

### Behaviour and Movement

The techniques noted above may be used to determine a location of a tag (and thus of the animal to which the tag is attached).

In some cases, further information may be determined based on the RSSI.

Tags are often attached to the head of the animal (such as the ear). The RSSI therefore tends to correlate to the distance of the head of the animal from the reader.

In some cases, this can be used to determine a behaviour of the animal, such as whether an animal is likely to have placed its head in a particular location like a feeding trough or water point. If a reader is placed in or below the location, the RSSI will tend to increase as the animal drops its head (for example, to eat or drink). This can be used to assist in distinguishing when an animal is eating or drinking as opposed to standing adjacent a feeding trough or water point.

In some embodiments, the location of a tag (and thus the animal) may be monitored over time. This can show changes in location, which can indicate a direction, path or movement. In this way, a series of readings may be able to track the movement of an animal through a reader system or other infrastructure.

### Tag Reading System

One situation in which the approach noted above may be useful is an electronic tag reading system which has multiple races. This may be provided at the entrance or exit to different areas within a stockyard or pasture, or when loading the animals to or from a transport such as a truck. Multiple races are used to increase the throughput. They may also be used to separate a group of animals into separate areas, where a first race leads to a first area and a second race leads to a second area.

When a single race is provided, it is relatively simple to determine a location of an animal in the tag reading system: it must be in the single race. However, where there are multiple races, this is no longer accurate: a reader in a first race may inadvertently read a tag on an animal in a second race. These “cross-reads” mean that a reading at a reader in a particular location may not correspond directly to the location of the animal. It can therefore be useful to determine the location (that is, which race) of an animal passing through a tag reading system.

FIG. 2 shows an example tag reading system 200 in which three races 201, 202, 203 are provided in sequence. Each race 201, 202, 203 has a pair of opposing walls which define a path through the race 201, 202, 203. A wall may be shared with a neighbouring race 201, 202, 203 in some cases. The width of each race 201, 202, 203 may be only slightly greater than the expected maximum width of the animals, to encourage animals to pass through in a single file, as this may increase the accuracy of readings of tags.

One or more readers 211, 212, 213 are associated with each race. Each reader 211, 212, 213 may be mounted in the walls of each corresponding race 201, 202, 203. For example, a reader may have coils which pass through both opposing walls of the correspondence. This may be configured to provide a generally uniform field through the race 201, 202, 203, such as by operating in a Helmholtz configuration.

In use, an animal enters through an entrance into a race 201, 202, 203, passes the corresponding reader 211, 212, 213, and exits through an exit of the race 201, 202, 203. As the animal passes through, one or more of the readers 211, 212, 213 generate one or more readings of the animal's tag. Each of these readings may have a different RSSI, depending on the distance of the animal's tag from the respective reader.

For example, as depicted in FIG. 2, animal 220 is within race 202. The readers 211, 212, and 213 each receive a reading from the electronic animal identification tag 230 attached to the ear of the animal 220. Reader 212 may obtain a first reading having a relatively high RSSI, since the distance between the animal identification tag 230 and the reader 212 is relatively low. Reader 213 may obtain a second reading having a relatively low RSSI, since the distance between the animal identification tag 230 and the reader 213 is relatively high. Reader 211 may not obtain a reading at all.

These readings may be sent to a controller 250, either by wire or wirelessly. The controller 250 can analyse the readings in real time or after some delay to determine the location of a tag, and thus the location of the animal to which the tag is attached.

Thus by using the RSSI to distinguish between readings of the same tag, it is possible to determine which location (that is, which race) an animal is in.

In some cases, a tag reading system may include physical structures to increase the attenuation of the signal. This can further decrease the RSSI over distance, and therefore may increase the overall accuracy of the determination of a location.

For example, a shield 241, 242 may be provided between neighbouring races. So shield 241 may be located between races 201 and 202 and shield 242 may be located between races 202 and 203. The shield may be configured to impede electromagnetic and/or radio frequency signals, and therefore may attenuate the strength of signals passing between the races. For example, a metal mesh, such as of copper or steel, may be located on or in a wall of the corresponding race. Thus, a cross-read (that is, a reading by a reader in a first race of a tag in a second race) may result in a significantly lower RSSI than a reading of a tag in the same race.

### Determining the Location of Animal: Second Embodiment

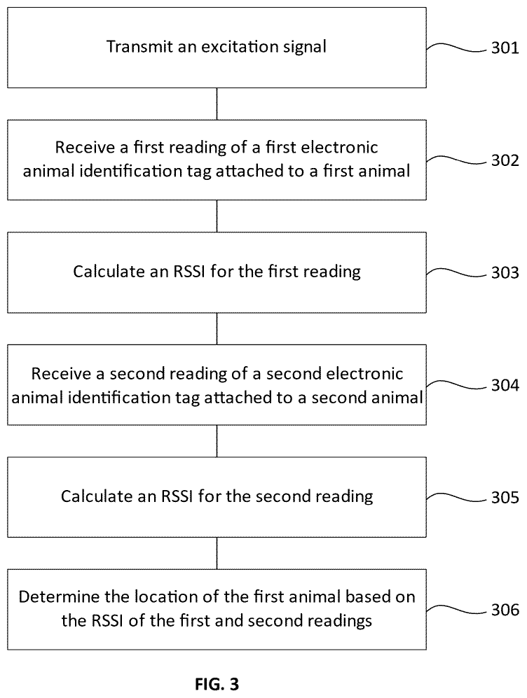

FIG. 3 shows an example method for determining the location of an animal according to a second embodiment. This method is performed using a system comprising at least one electronic tag reader. The electronic tag reader is configured to read an animal at a particular location. This location is known as a read zone. Alternatively, the location may be relative to other animals. For example, the location of a first animal may be ahead of a second animal in a sequence.

At step 301, an electronic tag reader transmits an excitation signal. The purpose of the excitation signal is to energise an electronic animal identification tag attached to an animal, such as an animal within a read zone. The excitation signal may be generated periodically, such as every 100 ms, and may last for a predetermined portion of the period, such as 40% of the period.

At step 302, an electronic tag reader (which may be the same electronic tag reader that performed step 101) receives a first reading of a first electronic animal identification tag. This reading comprises a first identifier, such as a 96-bit electronic product code. The purpose of the identifier is to uniquely identify the animal to which it is attached. For example, if multiple electronic animal identification tags are attached to the same animal, each tag may have the same identifier.

At step 303, a received signal strength indicator (RSSI) is calculated for the first reading. This may be performed by the electronic tag reader which performed step 302, or by a separate controller. The RSSI reflects the strength of the signal received from the tag. A greater signal strength leads to a higher RSSI. The RSSI may be computed as a function of the power level (such as in milliwatts or decibels with reference to one milliwatt) of the signal. The RSSI tends to vary by distance. Thus, all things being equal, a tag that is closer to the reader will tend to have a higher RSSI than a tag further from the reader.

At step 304, an electronic tag reader (which may be the same electronic tag reader that performed step 102) receives a second reading of a second electronic animal identification tag. This may occur in the same manner as step 302, and may occur at the same time as step 302. The second reading comprises a second identifier, which is different from the first identifier.

Because two (or more) readings were received, each having a different identifier, it is unclear which animal is within the read zone. This may occur when animals are spaced closely together or otherwise a signal from the second tag is conducted further than would otherwise be expected due to infrastructure or other environmental conditions.

At step 305, an RSSI is calculated for the second reading. This may be performed by the electronic tag reader which performed step 304, or by a separate controller. This may otherwise be performed in the same manner as step 303 and may occur at the same time as step 305.

At step 306, the location of the first animal is determined based on the RSSI of the first reading and the RSSI of the second reading.

For example, the first animal may be determined to be “in the read zone” or “outside of the read zone”. Alternatively, the first animal may be determined to be ahead of the second animal.

In some cases, this may occur by selecting the reading with the highest RSSI. Because the reader is configured to read from the read zone (and thus may be close to the read zone), a reading from a tag in the read zone may be expected to have a higher RSSI than a tag outside the read zone. Thus if the first reading has the highest RSSI, then the first animal may be determined to be in the read zone. Otherwise, the first animal may be determined to be outside of the read zone.

Where there are multiple readings over time, this may assist in determining the location of the first animal relative the second animal. For example, if multiple readings are taken at a regular period, then the RSSI of the readings of a particular tag may be expected to rise as it approaches the reader, and then fall as it moves away from the reader. The RSSI may therefore form a curve of RSSI over time. By comparing the curve of a first tag and the curve of a second tag with respect to time, it can be possible to determine the sequence of animals passing the reader. That is, the curve having an earlier maximum relates to an animal appearing earlier in the sequence. Thus the relative location of an animal can be determined.

In this way, the location of an animal can be determined using RSSI of one or more readings. This allows the identification of an animal within a predetermined location, such as a read zone.

### Tag Reading System

One situation in which the method noted above may be useful is a tag reading system which has a sequence of animals passing a set point.

For example, in an abattoir, the animals are hung on regularly spaced hooks. These pass a read zone at a predetermined location for determining which animals are moving through that point of the abattoir.

In some cases, the tags of two or more animals are read at the same time. This can occur when the excitation signal from a reader is sufficiently strong to energise multiple tags. It may also be affected by infrastructure conducting the signal further than would be expected.

When readings are received from multiple tags, there is a risk that an animal will be fail to be identified correctly. This can affect the traceability of the animals, where a first animal is identified by the reader as a second animal.

In addition, in some cases a sequence of animals may proceed through a read zone only when the current animal in the read zone has been identified. Such a system requires a accurate identification of animals for the system to function efficiently.

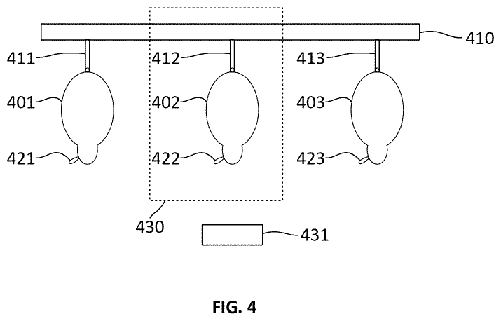

FIG. 4 shows an example tag reading system which may use the method of FIG. 3.

Animals 401, 402, 403 are each hung on a respective hook 411, 412, 413, which in turn are connected to a belt 410. The hooks 411, 412, 413 are equally spaced. An electronic animal identification tag 421, 422, 423 is attached to each animal 401, 402, 403. As the belt moves forward, each animal passes through a read zone 430 having a reader 431.

In use, the belt 410 may pause until a successful reading is received from a tag in the read zone. The reading corresponding to the tag in the read zone may be identified by determining the location of each tag from which a reading is received. Once a successful reading is received, the belt 410 may move so a subsequent animal is in the read zone.

Additionally or alternatively, the identification may be used to provide a record of how an animal has been routed. In use, animals may be moved in different direction, for example for sending to different destinations. By noting animals at multiple read zones, the path of each animal can be determined. This provides for traceability of animals through the abattoir.

### Predictive Algorithm

As noted above, the location may be determined solely on the basis of RSSI. However, in some cases, the location may be determined based on RSSI in combination with one or more other factors.

In some cases, the physical distance or configuration of the readers or other infrastructure may be incorporated into the determination. For example, certain metalwork in the infrastructure may conduct signals in a particular way. This may lead to the RSSI of a reading from a distant reader being higher than would be expected from the distance alone.

In some cases the output of one or more physical sensors, such as a weight sensor or motion sensor, may be used to indicate when an animal is within a particular location. If a reading from a particular reader indicates a high RSSI, this may ordinarily suggest that the animal is in the corresponding location. However, if a weight sensor indicates that there is no animal there, then the animal must be in a different location.

In some cases, a previous location of the tag and/or a time since a last location determination may be used to influence a determination of the position. If an animal was previously determined to be in a first location, it is unlikely the animal would then be in a second location which is physically inaccessible from the first location. Likewise, the expected rate of movement of an animal may restrict the range of possible locations for an animal based on a previous location.

In some cases, the reliance placed on the data from certain readers may be weighted differently. Where there are a sequence of readers, a greater weight may be placed on the readers on the outside of the sequence. This is because the outside readers are less likely to get cross-reads, since there is only one neighbouring reader. In other situations, a reader may be weighted based on a reliability: due to technical or structural differences, some readers may tend to provide more accurate readings.

In practice, one or more of these factors may be provided, in combination with the RSSI, to a predictive algorithm in order to determine a location. The use of multiple factors may increase the accuracy of the determination of the location.

In some cases, the predictive algorithm may comprise a model developed using artificial intelligence. For example, a neural network may be developed and trained based on a training set comprising sample data. During use, the RSSI and other data may be provided to the model, which then outputs a determined location on the basis of the trained neural network.

In some cases, multiple models are available, and are selected based on one or more criteria. A first model may be used in general cases, and a second model may be used when a predetermined amount of readings are received (such as more than 50 readings) or if readings are received from a predetermined number of different readers (such as more than three readers). The use of different models for determination at different times can increase the overall accuracy of the determination of location.

### Interpretation

Two embodiments of a method for determining the location of an animal have been noted above. In some cases, these may be combined in a single implementation.

Where a series of steps has been described, these steps need not necessarily be performed in the stated order (unless context requires otherwise). That is, steps may be performed out of order or in parallel in different embodiments.

The term “comprises” and other grammatical forms is intended to have an inclusive meaning unless otherwise noted. That is, they should be taken to mean an inclusion of the listed components, and possibly of other non-specified components or elements.

The present invention has been illustrated by the description of some embodiments. While these embodiments have been described in detail, this should not be taken to restrict or limit the scope of the claims to those details. Additional advantages and modifications will readily appear to those skilled in the art. Therefore, the invention in its broader aspects is not limited to the specific details of the illustrative examples shown and described. Accordingly, modifications may be made to the details without departing from the spirit or scope of the general inventive concept.

1. An electronic tag reading system for a plurality of animals in a plurality of locations, comprising:
at least one electronic animal identification tag attached to each of the plurality of animals;
a plurality of electronic tag readers
wherein a given electronic tag reader of the plurality of electronic tag readers is allocated to a given location comprising a read zone; and
a controller communicatively connected to the plurality of electronic tag readers;
wherein the system is configured to perform a method comprising:
receiving, from the plurality of electronic tag readers, a plurality of readings of electronic animal identification tags attached to the plurality of animals;
calculating a received signal strength indicator (RSSI) for each of the plurality of readings;
making a first determination of within which read zone the animal attached to a given electronic animal identification tag is located and;
at a time later than said first determination, making a second determination of within which read zone the animal attached to said given electronic animal identification tag is located;
wherein the second determination is based, at least in part, on a combination of the calculated received signal strength indicator and the read zone of the first determination.

2. A method, comprising:
(a) receiving, from a plurality of electronic tag readers, a plurality of readings of electronic animal identification tags attached to animals,
wherein a given electronic tag reader of the plurality of electronic tag readers is allocated to a given location comprising a read zone,
(b) calculating a received signal strength indicator (RSSI) for each of the plurality of readings;
(c) making a first determination of within which read zone the animal attached to a given electronic animal identification tag is located and;
(d) at a time later than said first determination, making a second determination of within which read zone the animal attached to said given electronic animal identification tag is located;
wherein the second determination is based, at least in part, on a combination of the calculated received signal strength indicator and the read zone of the first determination.

3. The system of claim 1, wherein the first and second determinations are used, in part, to determine the path through the electronic tag reading system of at least one of the plurality of animals.

4. The system of claim 1, wherein the first and second determinations are used, in part, to determine how at least one of the plurality of animals has been routed through the electronic tag reading system.

5. The system of claim 1, wherein a previous read zone determination of the tag is used to influence the first or second determination.

6. The system of claim 1, wherein a time between the first determination and the second determination is used to influence the first or second determination.

7. The system of claim 1, further comprising wherein the second determination is based, at least in part, on the rate of movement of the animal.

8. The system of claim 1, further comprising;
calculating a curve of RSSI over time for a first electronic identification tag;
calculating a curve of RSSI over time for a second electronic identification tag; and
comparing the curve of RSSI over time of the first electronic identification tag with the curve of RSSI over time of the second electronic identification tag,
wherein the comparison is used in making the first determination and/or the second determination.

9. The system of claim 1, wherein, after a plurality of animals have passed through the electronic tag reading system, the readings are analysed to determine the path through which the plurality of animals passed.

10. The system of claim 1, wherein the readings are analysed after some delay and the first and second determinations are made are said delay.

11. The system of claim 1, wherein the readings of at least one electronic tag reader of the plurality of electronic tag readers is provided with a weight based on the electronic tag reader's reliability.

12. The system of claim 11, wherein the reliability of a given reader is determined based on technical or structural differences between the plurality of electronic tag readers.

13. The system of claim 11, wherein the weight is independent of the RSSI.

14. The system of claim 1 wherein the first determination is further based on one or more of:
a configuration of the electronic tag readers;
a configuration of other infrastructure, other than the electronic tag readers;
the output of one or more physical sensors;
a previous location of the electronic animal identification tag; or
a time since a last determination of the location of the animal.

15. The system of claim 1, wherein the second determination is further based on one or more of:
a configuration of the electronic tag readers;
a configuration of other infrastructure, other than the electronic tag readers;
the output of one or more physical sensors;
a previous location of the electronic animal identification tag; or
a time since a last determination of the location of the animal.
